(19) United States
(12) Patent Application Publication
(10) Pub. No.: US 2024/0061553 A1
(43) Pub. Date: Feb. 22, 2024

(54) SYSTEMS AND METHODS FOR CUSTOMIZED PROCESSING AND VISUALIZATION OF DATA

(71) Applicant: Capital One Services, LLC, McLean, VA (US)

(72) Inventors: Mohamed SECK, Aubrey, TX (US); Louis BUELL, Chevy Chase, MD (US)

(73) Assignee: Capital One Services, LLC, McLean, VA (US)

(21) Appl. No.: 17/820,366

(22) Filed: Aug. 17, 2022

(51) Int. Cl. G06F 3/0483; G06F 16/16; H04L 67/06

(52) U.S. Cl. CPC G06F 3/0483; G06F 16/168; H04L 67/06

(57) ABSTRACT

A method may include receiving tabular data and receiving a first user input of a description of the tabular data and a second user input of a recipient of the tabular data or a report to be generated based on the tabular data. The method may include converting the tabular data to a text-based language to form converted tabular data and performing, using one or more first machine learning models, pre-processing of the converted tabular data. The method may include applying one or more second machine learning models to the converted tabular data based on the description, the recipient, a context of the converted tabular data, or a characteristic of the converted tabular data. The method may include performing one or more actions based on a result of applying the one or more second machine learning models.

### TECHNICAL FIELD

Various embodiments of this disclosure relate generally to techniques for customized processing and visualization of data, and, more particularly, to systems and methods for customized processing and visualization data for reporting, analysis, and/or the like.

### BACKGROUND

An organization (e.g., a company, a governmental agency, etc.) may use various computing systems in connection with its operations. For example, a company may use a human resources system, a customer management system, an accounting system, and/or the like. In some cases, the data from these systems may be analyzed, aggregated, and/or reported to other systems or individuals associated with the organization. However, different data formatting, categories, and/or the like may cause problems with respect to sharing data among different systems, analyzing data from different systems, or reporting data.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for customized processing and visualization of data for, e.g., data formatting, analysis, reporting, and/or the like.

A computer-implemented method for customized processing and visualization of data may include receiving, by a server device, tabular data. The computer-implemented method may include receiving a first user input of a description of the tabular data and a second user input of a recipient of the tabular data or a report to be generated based on the tabular data. The computer-implemented method may include converting the tabular data to a text-based language to form converted tabular data. The computer-implemented method may include performing, using one or more first machine learning models, pre-processing of the converted tabular data based on the description or the recipient. Different first machine learning models may have been trained to perform different pre-processing operations for different descriptions or different recipients. The computer-implemented method may include applying one or more second machine learning models to the converted tabular data based on the description, the recipient, a context of the converted tabular data, or a characteristic of the converted tabular data. Different second machine learning models may have been trained and may be applied for the different descriptions, the different recipients, different contexts, different characteristics, or different visualizations. The computer-implemented method may include performing one or more actions based on a result of applying the one or more second machine learning models. The one or more actions may include providing a virtual dashboard to visualize the converted tabular data or the result, and generating one or more reports for the converted tabular data or the result.

A server device may include at least one memory storing instructions and at least one processor executing the instructions to perform operations for customized processing and visualization of data. The operations may include receiving tabular data. The operations may include receiving a first user input of a description of the tabular data and a second user input of a recipient of the tabular data or a report to be generated based on the tabular data. The operations may include converting the tabular data to a text-based language to form converted tabular data. The operations may include performing, using one or more first machine learning models, pre-processing of the converted tabular data based on the description or the recipient. Different first machine learning models may have been trained to perform different pre-processing operations for different descriptions or different recipients. The operations may include applying one or more second machine learning models to the converted tabular data based on the description, the recipient, a context of the converted tabular data, or a characteristic of the converted tabular data. Different second machine learning models may have been trained and may be applied for the different descriptions, the different recipients, different contexts, different characteristics, or different visualizations. The operations may include performing one or more actions based on a result of applying the one or more second machine learning models. The one or more actions may include providing a virtual dashboard to visualize the converted tabular data or the result, and generating one or more reports for the converted tabular data or the result.

A non-transitory computer-readable medium may store instructions that, when executed by a processor, cause the processor to perform a method for customized processing and visualization of data. The method may include receiving tabular data. The method may include receiving a first user input of a description of the tabular data and a second user input of a recipient of the tabular data or a report to be generated based on the tabular data. The method may include converting the tabular data to a text-based language to form converted tabular data. The method may include performing, using one or more first machine learning models, pre-processing of the converted tabular data based on the description or the recipient. Different first machine learning models may have been trained to perform different pre-processing operations for different descriptions or different recipients. The method may include applying one or more second machine learning models to the converted tabular data based on the description, the recipient, a context of the converted tabular data, or a characteristic of the converted tabular data. Different second machine learning models may have been trained and may be applied for the different descriptions, the different recipients, different contexts, different characteristics, or different visualizations. The method may include performing one or more actions based on a result of applying the one or more second machine learning models. The one or more actions may include providing a virtual dashboard to visualize the converted tabular data or the result, and generating one or more reports for the converted tabular data or the result.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for customized processing and visualization of data, according to one or more embodiments.

FIG. 2 depicts a flowchart of an exemplary method of customized processing and visualization of data, according to one or more embodiments.

FIGS. 3A and 3B depict an example of customized processing and visualization of data, according to one or more embodiments.

FIGS. 4A-4I depict an example of using a computing platform for customized processing and visualization of data, according to one or more embodiments.

FIG. 5 depicts an example of a computing device, according to one or more embodiments.

### DETAILED DESCRIPTION OF EMBODIMENTS

According to certain aspects of the disclosure, methods and systems are disclosed for customized processing and visualization of data, e.g., for re-formatting, analysis, reporting, and/or the like. Conventional techniques may not provide a suitable way to process data from various computing systems in an accurate and/or time-efficient manner. Accordingly, improvements in technology relating to data processing are needed.

As will be discussed in more detail below, in various embodiments, systems and methods are described for customized processing and visualization of data based on an analysis to be performed, a recipient for reporting, and/or the like. By training a machine-learning model, e.g., via supervised or semi-supervised learning, to learn associations between types of analyses or different recipients and data from a computing system, the trained machine-learning model may be usable to determine and perform customized processing of the data.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining or “in response to detecting,” depending on the context. Similarly, the phrase “if it is determined” or f [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, certain embodiments may select a first machine learning model from multiple possible machine learning models to use to perform customized data processing based on the data, a source of the data, a recipient of reporting related to the data, an analysis to be performed on the data, and/or the like. In another exemplary use case, a machine-learning model may be trained to perform certain analyses, generate certain reports, format the data in a certain manner, and/or the like. Different first machine learning models may be trained to perform different pre-processing operations.

While several of the examples above involve tabular data, it should be understood that techniques according to this disclosure may be adapted to any suitable type of data, including any type of structured or unstructured data. It should also be understood that the examples above are illustrative only. The techniques and technologies of this disclosure may be adapted to any suitable activity.

Presented below are various aspects of machine learning techniques that may be adapted to perform customized data processing. As will be discussed in more detail below, machine learning techniques adapted to perform customized processing and visualization of data may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

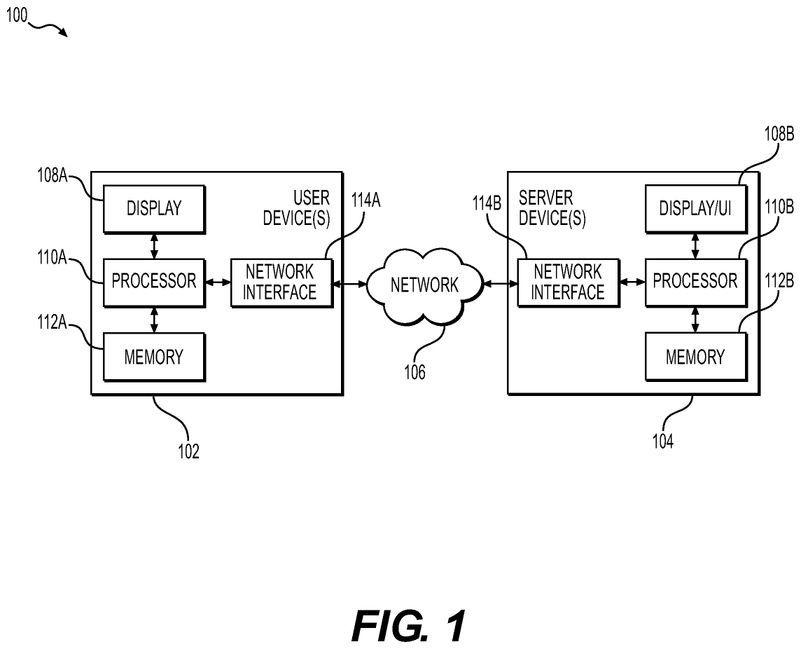

FIG. 1 depicts an exemplary environment 100 that may be utilized with techniques presented herein. The environment 100 may include one or more user devices 102, one or more server devices 104, and a network 106. Although FIG. 1 depicts a single user device 102, server device 104, and network 106, the embodiments described herein are applicable to environments 100 that include two or more user devices 102, server devices 104, and/or networks 106 in any suitable arrangement.

The user device 102 may include a display 108A, a processor 110A, a memory 112A, and/or a network interface 114A. The user device 102 may be a mobile device, such as a smartphone, a cell phone, a tablet, a laptop computer, etc., a desktop computer, and/or the like. The user device 102 may execute, by the processor 110A, one or more instructions stored in the memory 112A to, e.g., perform customized processing and visualization of data, or train and/or use one or more machine learning models to perform the customized processing and visualization of data, as described elsewhere herein. One or more components of the user device 102 may generate, or may cause to be generated, one or more graphic user interfaces (GUIs) based on instructions/information stored in the memory 112A, instructions/information received from the server device 104, and/or the like and may cause the GUIs to be displayed via the display 108A. The GUIs may be, e.g., mobile application interfaces or browser user interfaces and may include text, input text boxes, selection controls, and/or the like. The display 108A may include a touch screen or a display with other input systems (e.g., a mouse, keyboard, etc.) for an operator of the user device 102 to control the functions of the user device 102. The network interface 114A may be a transmission control protocol/Internet protocol (TCP/IP) network interface, or another type of wired or wireless communication interface, for Ethernet or wireless communications with the server device 104 via the network 106.

The server device 104 may include a display 108B, a processor 1106, a memory 112B, and/or a network interface 114B. The server device 104 may be a computer, system of computers (e.g., rack server(s)), or a cloud service computer system (e.g., in a data center). The server device 104 may execute, by the processor 1106, one or more instructions stored in the memory 112B to, e.g., perform customized processing and visualization of data, or train and/or use one or more machine learning models to perform the customized processing and visualization of data, as described elsewhere herein. One or more components of the server device 104 may generate, or may cause to be generated, one or more graphic user interfaces (GUIs) based on instructions/information stored in the memory 1126, instructions/information received from the user device 102, and/or the like and may cause the GUIs to be displayed via the display 108B.

The network 106 may include one or more wired and/or wireless networks, such as the Internet, an intranet, a wide area network (“WAN”), a local area network (“LAN”), a personal area network (“PAN”), a cellular network (e.g., a 3G network, a 4G network, a 5G network, etc.) or the like. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “webpage” generally encompasses a location, data store, or the like that is, e.g., hosted and/or operated by a computer system so as to be accessible online, and that may include data configured to cause a program such as a web browser to perform operations such as send, receive, or process data, generate a visual display and/or an interactive interface, or the like. The user device 102 and the server device 104 may be connected via the network 106, using one or more standard communication protocols. The user device 102 and the server device 104 may transmit and receive messages from each other across the network 106, as discussed in more detail below.

As discussed in further detail below, the one or more components of exemplary environment 100 may process data from one or more user devices 102 and/or one or more server devices 104. Additionally, or alternatively, and as discussed in further detail below, the one or more components of exemplary environment 100 may generate, store, train and/or use a machine-learning model for customized processing and visualization of the data. The exemplary environment 100 or one of its components may include or be in operable communication with a machine-learning model and/or instructions associated with the machine-learning model, e.g., instructions for generating a machine-learning model, training the machine-learning model, using the machine-learning model, etc. The exemplary environment 100 or one of its components may include instructions for retrieving data, adjusting data, e.g., based on the output of the machine-learning model, and/or operating a display to output data, e.g., as adjusted based on the machine-learning model. The exemplary environment 100 or one of its components may include, provide, obtain, and/or generate training data.

In some embodiments, a system or device other than the components shown in the exemplary environment 100 may be used to generate and/or train the machine-learning model. For example, such a system may include instructions for generating and/or obtaining the machine-learning model, the training data and ground truth, and/or instructions for training the machine-learning model. A resulting trained-machine-learning model may then be provided to the exemplary environment 100 or one of its components and, for example, stored in the memory 112A and/or 112B.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. Certain embodiments may utilize, for training a machine learning model, unsupervised learning where, e.g., the sample of training data may not include pre-assigned labels or scores to aid the learning process or may utilize semi-supervised learning where a combination of training data with pre-assigned labels or scores and training data without pre-assigned labels or scores is used to train a machine learning model.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., may be used to compare the output of the trained model with the ground truth for that portion of the training data to evaluate an accuracy of the trained model. The training of the machine-learning model may be configured to cause the machine-learning model to learn associations between training data (e.g., computing system data) and ground truth data, such that the trained machine-learning model is configured to determine an output in response to the input data based on the learned associations.

In various embodiments, the variables of a machine-learning model may be interrelated in any suitable arrangement in order to generate the output. For example, in some embodiments, the machine-learning model may include an architecture that is configured to classify data from a computing system based on a subject matter of the data or an intended recipient of a report to be generated from the data. For example, the machine-learning model may include one or more neural networks configured to identify features in the data, and may include further architecture, e.g., a connected layer, neural network, etc., configured to determine a relationship between the identified features in order to determine a location in the data. In certain embodiments, the machine learning model may include a single node for classification, as described elsewhere herein.

Although depicted as separate components in FIG. 1, it should be understood that a component or portion of a component in the exemplary environment 100 may, in some embodiments, be integrated with or incorporated into one or more other components. For example, a portion of the display 108A may be integrated into the user device 102 or the like. In another example, the server device 104 may be integrated in a data storage system. In some embodiments, operations or aspects of one or more of the components discussed above may be distributed amongst one or more other components. Any suitable arrangement and/or integration of the various systems and devices of the exemplary environment 100 may be used.

Further aspects of customized processing and visualization of data or of the machine-learning model and/or how it may be trained or used to process and visualize data in a customized manner are discussed in further detail below. In the following disclosure, various acts may be described as performed or executed by a component from FIG. 1, such as the user device 102, the server device 104, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

The example environment 100 described above is provided merely as an example, and may include additional, fewer, different, or differently arranged aspects than depicted in FIG. 1.

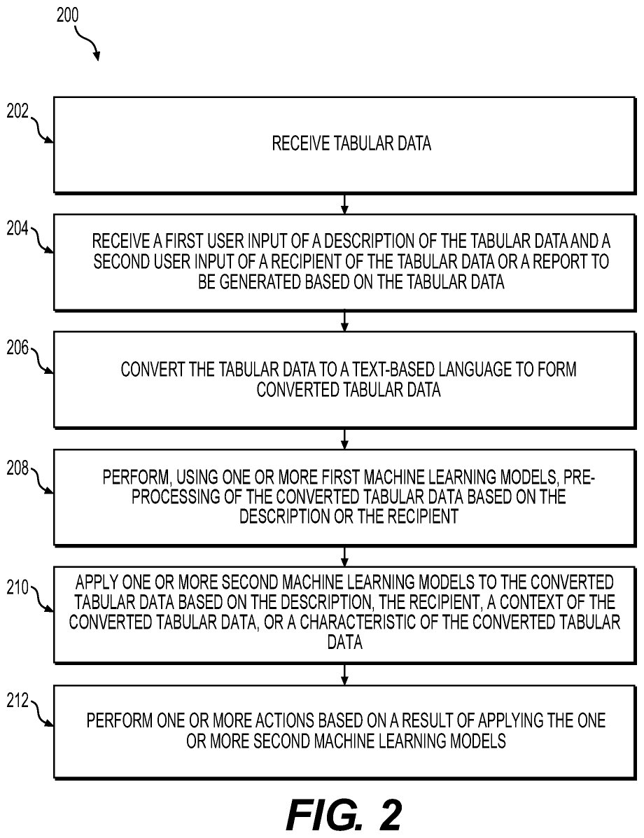

FIG. 2 depicts a flowchart of an exemplary method 200 of customized data processing, according to one or more embodiments. In some embodiments, the method 200 may be performed by a server device 104 or a data platform hosted on the server device 104.

At step 202, the method 200 may include receiving tabular data. For example, the server device 104 may receive the tabular data as an upload from a user device 102, may access the tabular data in memory of the server device 104 or another server device 104, may receive the tabular data from a computing system that includes one or more user devices 102 and/or server devices 104, and/or the like. The server device 104 may receive the data in a streaming manner, in bulk at one time, at a scheduled time, and/or the like. The tabular data may include a spreadsheet, a comma separated values (CSV) file, and/or the like. Although certain embodiments are described as relating to tabular data, any type of structured or unstructured data may be used in certain embodiments.

The method 200 may include, at step 204, receiving a first user input of a description of the tabular data and a second user input of a recipient of the tabular data or a report to be generated based on the tabular data. For example, the server device 104 or a computing platform (e.g., a set of user interfaces) hosted on the server device 104 may receive the first user input and/or the second user input. In some embodiments, the server device 104 may receive the first user input and/or the second user input from a user device 102. The server device 104 may receive the first user input and/or the second user input at the same time as the tabular data in step 202, after receiving the tabular data (e.g., the server device 104 may prompt the user of the user device 102 to input the first user input and/or the second user input after receiving the tabular data), and/or the like. The first user input and/or the second user input may include a menu selection, a radio button selection, a drop-down menu selection, a typing or text, and/or the like.

The first user input of the description may identify a subject matter of the tabular data (e.g., identify the tabular data as human resources data, accounting data, etc.), a source of the data (e.g., a computing system that generated or stored the tabular data), and/or the like. The second user input of the recipient may identify a destination computing system for the tabular data or the report, an individual or group of individuals to receive the report and/or the tabular data, and/or the like.

In some embodiments, the server device 104 may use one or more machine learning models to determine a likely description and/or a likely recipient based on the source of the tabular data, the subject of the tabular data, and/or the like. The server device 104 may use the likely description and/or the likely recipient instead of the first user input or the second user input, thereby reducing or eliminating a need for user input. Alternatively, the server device 104 may output the likely description and/or the likely recipient for display via a user device 102, and the server device 104 may receive the first user input and/or the second user input to confirm or modify the likely description and/or the likely recipient, respectively.

At step 206, the method 200 may include converting the tabular data to a text-based language to form converted tabular data. For example, the server device 104 may convert the tabular data after receiving the first user input and/or the second user input, based on receiving third user input (e.g., selection of button on a user interface) to perform the conversion, automatically after conclusion of a preceding step, and/or the like. In some embodiments, the server device 104 may convert the tabular data after receiving the tabular data at step 202 but prior to receiving the first user input and/or the second user input.

The conversion of the tabular data may include converting the tabular data into a form compatible with subsequent analytics processing, report generation, data visualization, and/or the like. For example, the server device 104 may convert the tabular data to a JavaScript Object Notation (JSON) format, an extensible markup language (XML) format, and/or the like. In some embodiments, the conversion may include copying the values from a table to a data structure that includes delimiters for separation of values, while removing any formatting (e.g., different fonts, text coloring, etc.) from the tabular data. Additionally, or alternatively, the converting may include organizing the data, applying headers or footers to the tabular data, inputting the tabular data to a template, converting certain notations in the tabular data to different notations, and/or the like.

At step 208, the method 200 may include performing, using one or more first machine learning models, pre-processing of the converted tabular data based on the description or the recipient. For example, the server device 104 may perform the pre-processing after converting the tabular data to the text-based language. In some embodiments, the server device 104 may perform the pre-processing prior to the conversion at step 206. The server device 104 may perform the pre-processing automatically at the conclusion of a preceding step, based on receiving user input to perform the pre-processing, at a scheduled time, and/or the like.

The pre-processing may include applying a formatting to the converted tabular data. For example, the server device 104 may modify column and/or row labels to be consistent with naming rules, may combine or separate columns and/or rows, may add and/or remove columns and/or rows, may re-arrange columns and/or rows, may remove and/or add trailing values to data elements, may convert number values to string values or string values to number values, may apply consistent formatting across elements in the same column of data (e.g., may apply consistent decimal places), and/or the like.

In some embodiments, the server device 104 may select the one or more first machine learning models from multiple first machine learning models based on the description or the recipient. For example, certain first machine learning models may be trained to perform the pre-processing for converted tabular data associated with certain descriptions or certain recipients. As a specific example, the multiple machine learning models may include a first machine learning model for accounting data, a second machine learning model for payroll data, a third machine learning model for user log data, and/or the like, and the server device 104 may select the first, second, or third machine learning models depending on whether the converted tabular data is accounting data, payroll data, or user log data. In this way, certain embodiments may provide for more accurate processing of converted tabular data compared to use of a machine learning model that is generalized for various descriptions and/or recipients. In addition, in this way, certain embodiments may conserve computing resources or processing resources by using a machine learning model specifically trained for certain contexts compared to using a more generalized machine learning model which may have to perform superfluous processing for multiple contexts.

The method 200 may include, at step 210, applying one or more second machine learning models to the converted tabular data based on the description, the recipient, a context of the converted tabular data, or a characteristic of the converted tabular data. For example, the server device 104 may apply the one or more second machine learning models. The server device 104 may apply the one or more second machine learning models after performing the pre-processing at step 208, after converting the tabular data at step 206 (e.g., if the converting is performed after the pre-processing at step 208), and/or the like. The server device 104 may perform the applying automatically at the conclusion of a preceding step, based on receiving user input to perform the applying, at a scheduled time, and/or the like.

The context of the converted tabular data may include a priority associated with the converted tabular data (e.g., high, medium, or low priority) as determined by the server device 104 using a machine learning model or as input by a user, an industry of the organization associated with the converted tabular data, and/or the like. The characteristic of the converted tabular data may include a granularity of the data (e.g., some accounting data may include one column for revenue of the organization whereas other accounting data may include separate columns for revenue of different business units), a quality of the data (e.g., whether data elements are missing from columns of the data for certain rows), and/or the like.

The one or more second machine learning models may be trained to process the converted tabular data. For example, the one or more second machine learning models may perform a calculation on the converted tabular data (e.g., a sum, subtraction, calculation, etc.), may perform an analysis on the converted tabular data (e.g., a trend analysis, a forecasting, an anomaly detection, etc.), may generate a report for the converted tabular data (e.g., a report that includes text to describe the data or processing on the data, visualizations such as a pie chart, a bar chart, or a pivot chart), and/or the like. As a specific example for accounting data, the server device 104 may apply a second machine learning model that calculates revenue over a particular time period, forecasts revenue at a point in time in the future, and generates a pie chart illustrating portions of a total revenue that come from different revenue sources.

The server device 104 may select the one or more second machine learning models from multiple possible second machine learning models. For example, different second machine learning models may be trained for different descriptions, recipients, contexts, visualizations, or characteristics, and the server device 104 may select the one or more second machine learning models based on these aspects. As a specific example, different second machine learning models may be trained for accounting data than for payroll data. As another specific example, different machine learning models may be trained for accounting data to be used in an audit or provided to an auditor than to be used for an investor prospectus or provided to a chief executive officer (CEO). In this way, certain embodiments may provide more accurate processing through selection of specially trained models. In addition, in this way, certain embodiments may conserve computing resources or processing resources by using a machine learning model specifically trained for certain contexts compared to using a more generalized machine learning model which may have to perform superfluous processing for multiple contexts.

The method 200 may include, at 212, performing one or more actions based on a result of applying the one or more second machine learning models. For example, the server device 104 may perform the one or more actions. In some embodiments, the server device 104 may perform the one or more actions after applying the one or more second machine learning actions, in conjunction with applying the one or more second machine learning models, based on input to a user interface by a user of a platform, and/or the like.

The one or more actions may include, for example, outputting the report for display via a user interface (e.g., a dashboard) or to a user device 102 (e.g., an application installed on the user device 102). Additionally, or alternatively, the one or more actions may include sending a message (e.g., an email, a text message, etc.) that includes a generated report. Additionally, or alternatively, the one or more actions may include storing a generated report in memory. Additionally, or alternatively, the one or more actions may include scheduling a meeting. For example, the server device 104 may use one or more machine learning models to identify relevant parties to invite to or attend a meeting based on, e.g., the subject of the tabular data, results of forecasts or other analyses performed, and/or the like. The server device 104 may then generate a calendar invite for the meeting and may send the calendar invite to accounts associated with the relevant parties. Similarly, the server device 104 may determine a set of recipients of a report using a machine learning model based on the content of the report, results of analyses performed on the data, etc.

In some embodiments, the one or more actions may include generating the report rather than generating the report in connection with step 210. For example, the server device 104 may input results of calculations or analyses into a report template, may generate text to describe the calculations or the analyses (e.g., text such as “Revenue has increased by [x]% from the previous quarter”) and may input the text into the report template, may generate and/or input visualizations into the report template, and/or the like. Similarly, the server device 104 may customize the report template based on the calculations or analyses performed, the recipient of the report, the subject of the tabular data, and/or the like.

The example method 200 described above is provided merely as an example, and may include additional, fewer, different, or differently arranged aspects than depicted in FIG. 2.

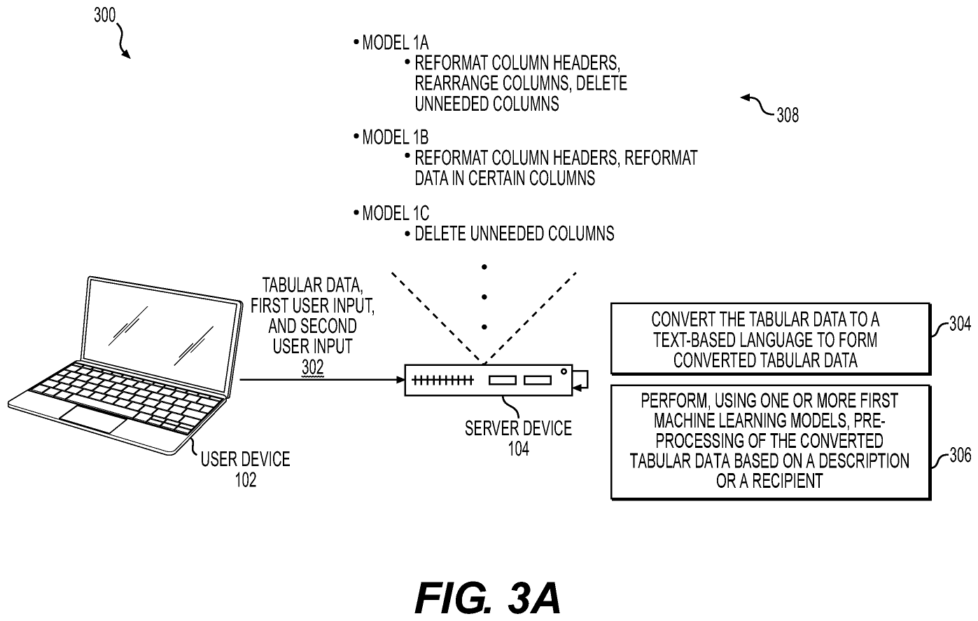

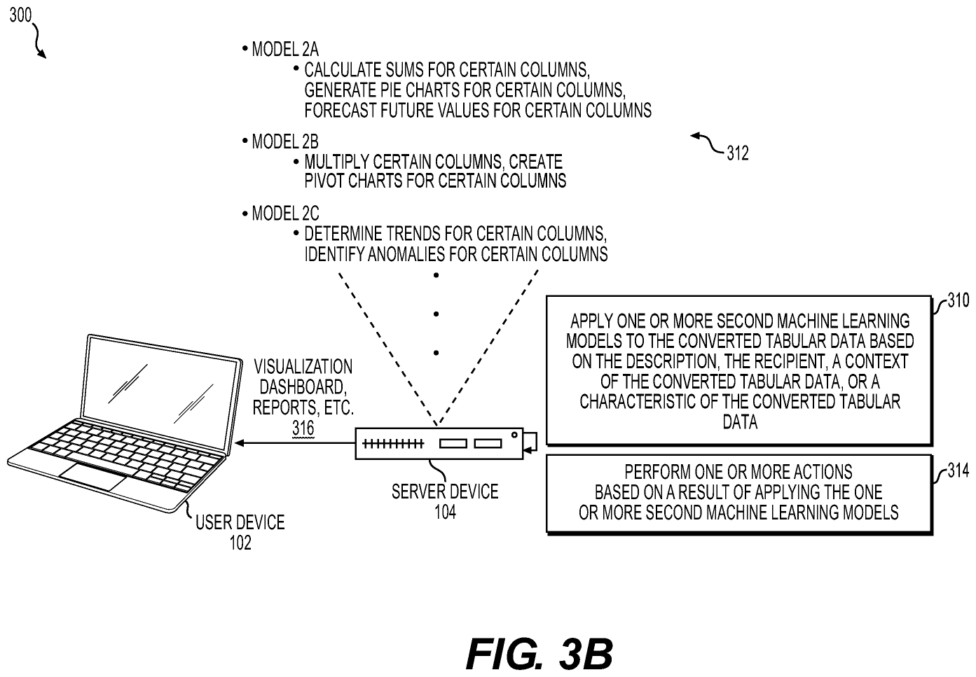

FIGS. 3A and 3B depict an example 300 of customized processing and visualization of data, according to one or more embodiments. As illustrated in FIG. 3A, the example 300 includes a user device 102 and a server device 104. As illustrated at 302, the user device 102 may send, to the server device 104, tabular data, first user input, and second user input. For example, the user device 102 may send, and the server device 104 may receive, the tabular data in a manner similar to that described above in connection with step 202 of FIG. 2. In addition, the user device 102 may send, and the server device 104 may receive, the first user input and the second user input in a manner similar to that described above in connection with step 204 of FIG. 2.

As illustrated at 304, the server device 104 may convert the tabular data to a text-based language to form converted tabular data. For example, the server device 104 may convert the tabular data to a JSON format, in a manner similar to that described above in connection with step 206 of FIG. 2. As illustrated at 306, the server device 104 may perform, using one or more first machine learning models, pre-processing of the converted tabular data based on a description of the tabular data or a recipient of the converted tabular data or a report to be generated from the converted tabular data. For example, the server device 104 may perform the pre-processing on the converted tabular data in a manner similar to that described above in connection with step 208 of FIG. 2. Reference number 308 illustrates examples of possible available first machine learning models from which the server device 104 may select the one or more first machine learning models for the pre-processing. For example, the possible available first machine learning models may include a “MODEL 1A” trained to reformat column headers, rearrange columns, or delete unneeded columns from the converted tabular data, a “MODEL 1B” trained to reformat column headers or reformat data in certain columns of the converted tabular data, a “MODEL 1C” trained to delete unneeded columns from the converted tabular data, and/or the like.

Turning to FIG. 3B, and as illustrated at 310, the server device 104 may apply one or more second machine learning models to the converted tabular data based on the description of the converted tabular data, the recipient of the converted tabular data or the report, a context of the converted tabular data, or a characteristic of the converted tabular data. For example, the server device 104 may apply the one or more second machine learning models in a manner similar to that described above in connection with step 210 of FIG. 2. Reference number 312 illustrates examples of possible available second machine learning models from which the server device 104 may select the one or more second machine learning models. For example, the possible available second machine learning models may include a “MODEL 2A” trained to calculate sums for certain columns, generate pie charts for certain columns, or forecast future values for certain columns of the converted tabular data, a “MODEL 2B” trained to multiply certain columns or create pivot charts for certain columns of the converted tabular data, a “MODEL 2C” trained to determine trends for certain columns or identify anomalies for certain columns of the converted tabular data.

As illustrated at 314, the server device 104 may perform one or more actions based on a result of applying the one or more second machine learning models. For example, the server device 104 may perform the one or more actions in a manner similar to that described above in connection with step 212 of FIG. 2. As illustrated at 316, as specific examples of the one or more actions, the server device 104 may provide a visualization dashboard (e.g., a virtual dashboard), reports, etc. for display via the user device 102. For example, the visualization dashboard may include an interactive user interface that displays pie charts, trend lines, and/or the like related to the calculations and/or analyses performed on the converted tabular data.

The example 300 described above is provided merely as an example, and may include additional, fewer, different, or differently arranged aspects than depicted in FIGS. 3A and 3B.

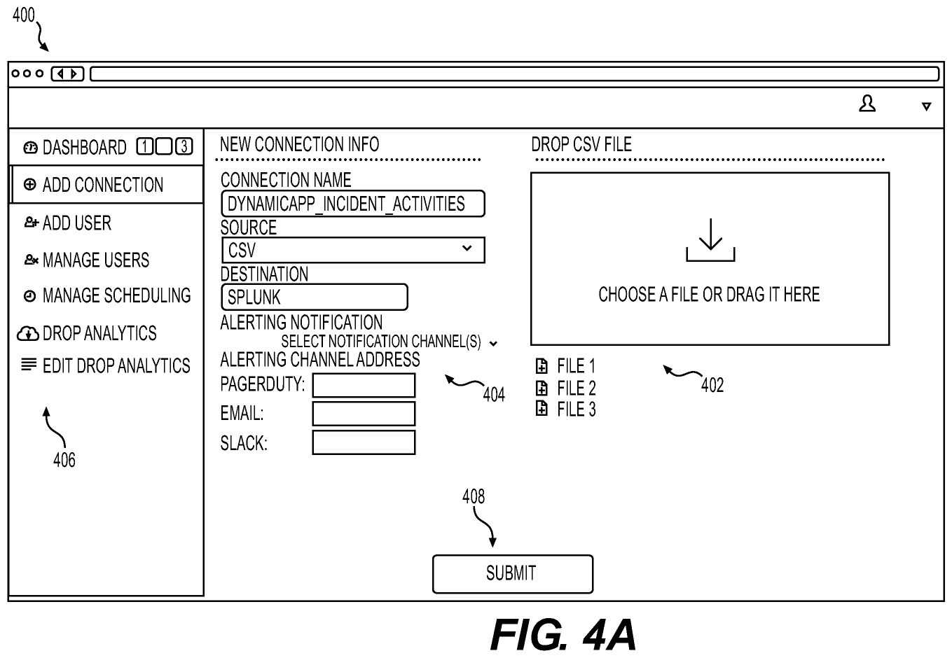

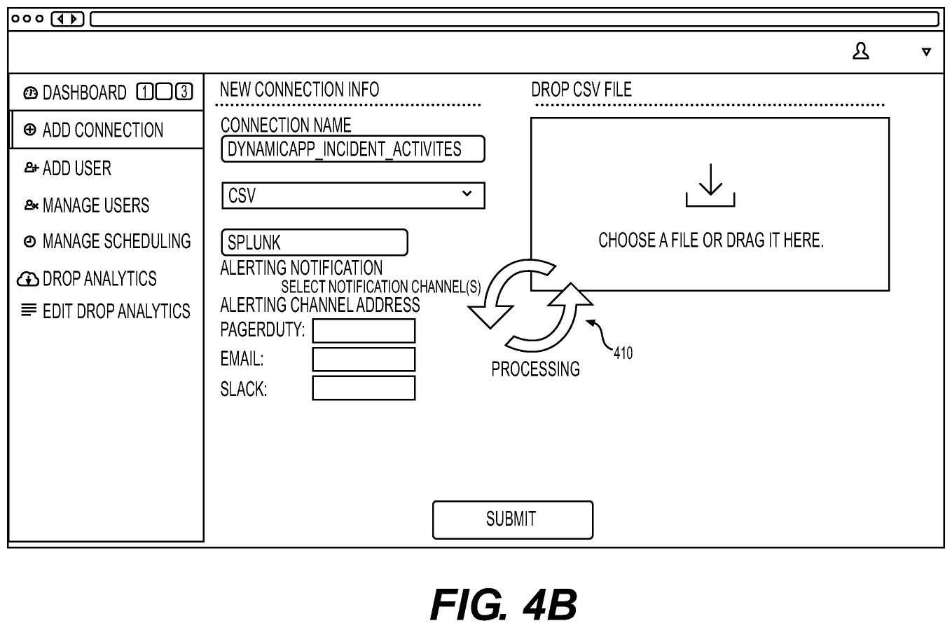

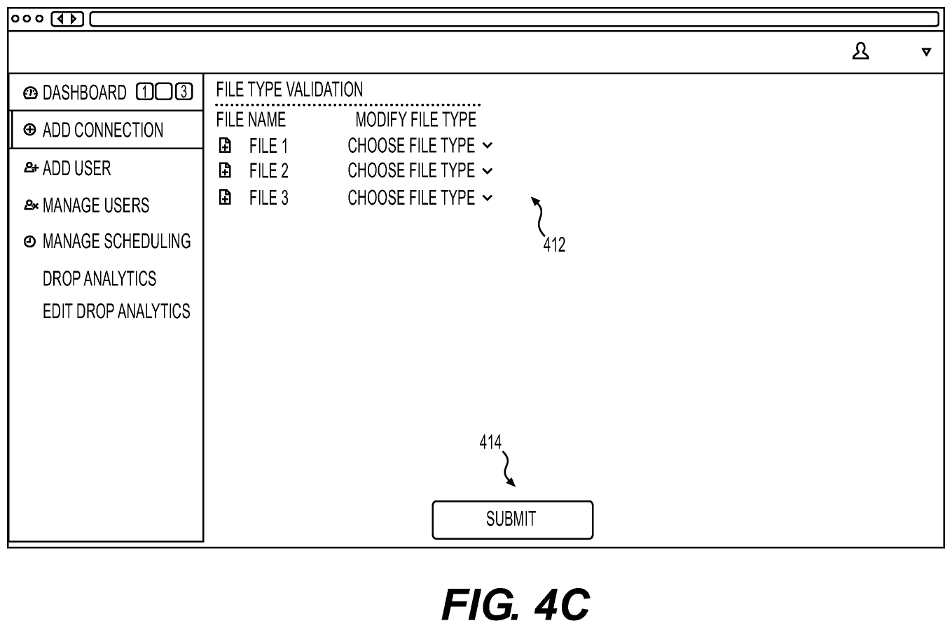

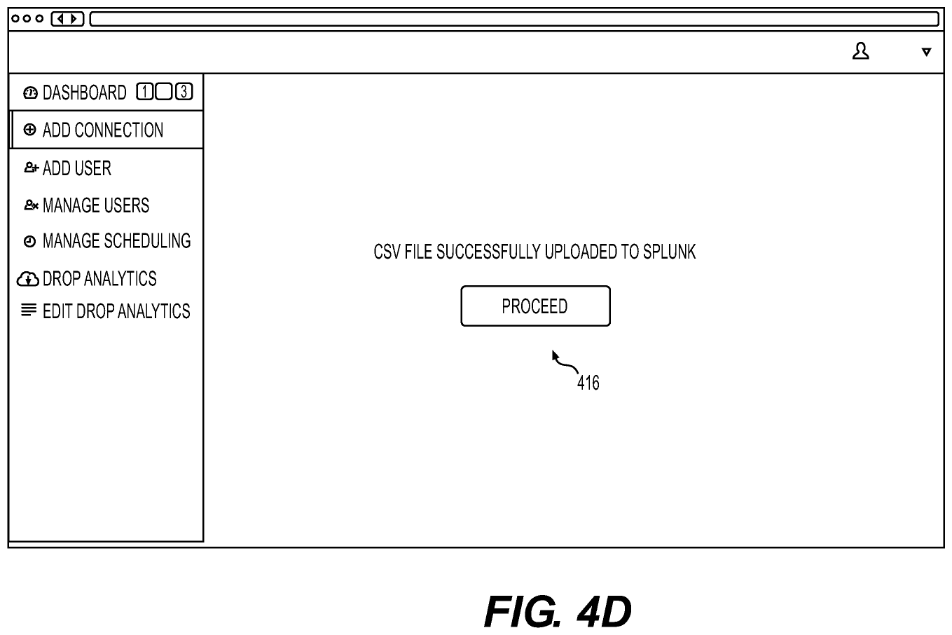

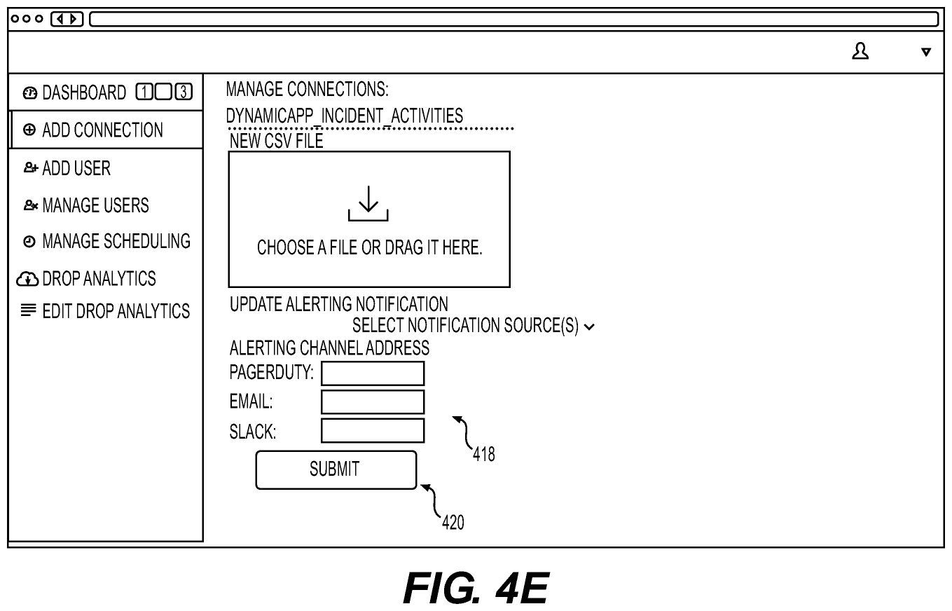

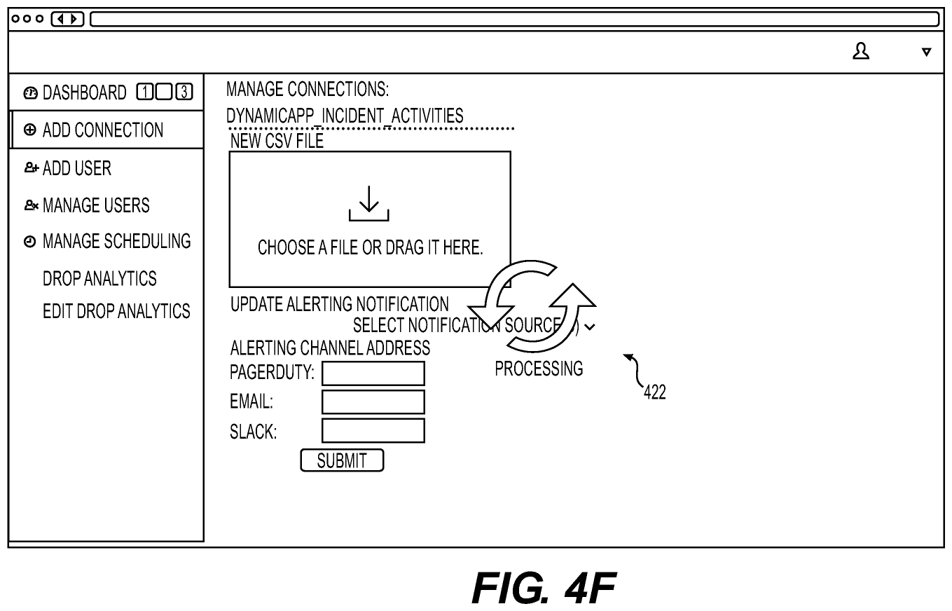

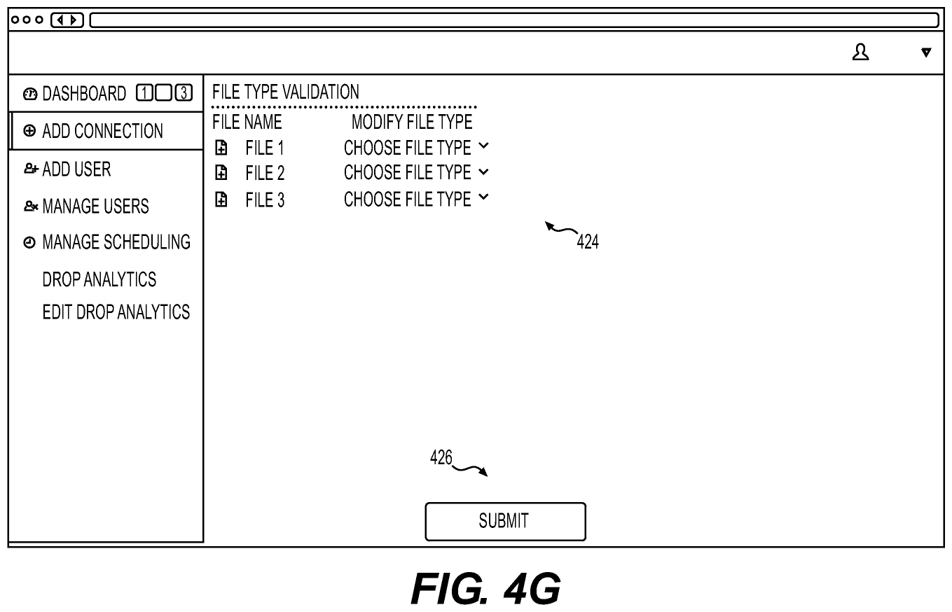

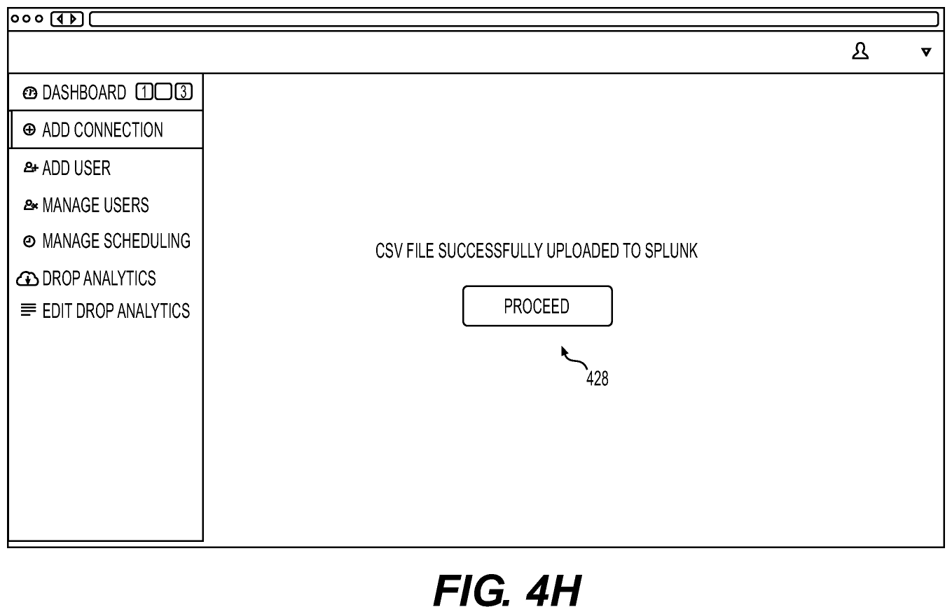

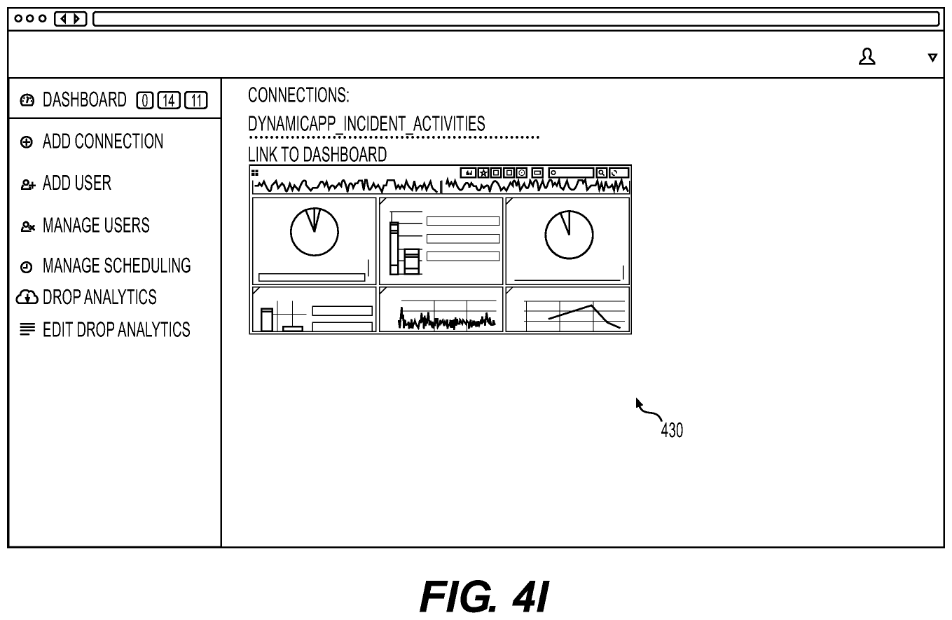

FIGS. 4A-4I depict an example 400 of using a computing platform for customized processing and visualization of data, according to one or more embodiments. For example, FIGS. 4A-4I illustrate a user interface (e.g., a web-based user interface) that may be displayed on a user device 102 by the server device 104. As illustrated in FIG. 4A, the user interface may include various user interface elements for controlling operations of the server device 104. For example, and as illustrated at 402, the user interface may include user interface elements where the user may choose or drag-and-drop one or more files (e.g., “FILE 1,” “FILE 2,” and “FILE 3”) that include the tabular data. As illustrated at 404, the user interface may include one or more user interface elements where the user may specify settings for processing of the tabular data, such as a file type of the files (“SOURCE”), a destination to process the tabular data (e.g., a “SPLUNK” server device 104), recipients of results of the processing (“ALERTING CHANNEL ADDRESS”), and/or the like.

As illustrated at 406, the user interface may include user interface elements where the user may specify other settings, such as adding users (“ADD USERS”), managing users (“MANAGE USERS”), managing scheduling of the processing (“MANAGE SCHEDULING”), and/or the like. As illustrated at 408, the user interface may include a button (or another type of control element) to submit the files to the server device 104 and/or initiate processing by the server device 104.

Turning to FIG. 4B, and as illustrated at 410, the user interface may display a user interface element that indicates that the files are being processed by the server device 104. Turning to FIG. 4C, and as illustrated at 412, the user interface may include one or more user interface elements (e.g., drop-down menus) where the user may specify the file type for the files if the server device 104 makes an incorrect determination of the file type. As illustrated at 414, the user interface may include one or more buttons where the user may cause the file type information to be sent to the server device 104.

Turning to FIG. 4D, and as illustrated at 416, the user interface may include one or more user interface elements that indicate successful uploading of the files to the server device 104 and/or where the user can cause the server device 104 to start processing the files (e.g., the “PROCEED” button). In FIG. 4E, and as illustrated at 418, the user interface may include one or more elements where the user can upload additional files or make modifications to destinations for reports or analyses. The user may send these updates to the server device 104 by selecting, e.g., the “SUBMIT” button illustrated at 420. FIG. 4F illustrates at 422 that the user interface may indicate that the additional files are being processed by the server device 104.

Turning to FIG. 4G, and as illustrated at 424 and 426, the user interface may include user interface elements where the user can identify file types for the additional files and submit these updates to the server device 104, in a manner similar to that described above. FIG. 4H illustrates at 428 that the user interface may include one or more user interface elements that indicates successful uploading of the additional files to the server device 104 and/or where the user can cause the server device 104 to process the additional files, in a manner similar to that described above. As illustrated at 430 in FIG. 4I, the user interface may display reports, visualizations for analysis results, and/or the like as provided by the server device 104. For example, FIG. 4I may illustrate an example visualization dashboard described herein. The reports and/or visualizations may be updated in real-time (or near real-time) as data is received and processed by the server device 104.

The example 400 described above is provided merely as an example, and may include additional, fewer, different, or differently arranged aspects than depicted in FIGS. 4A-4I.

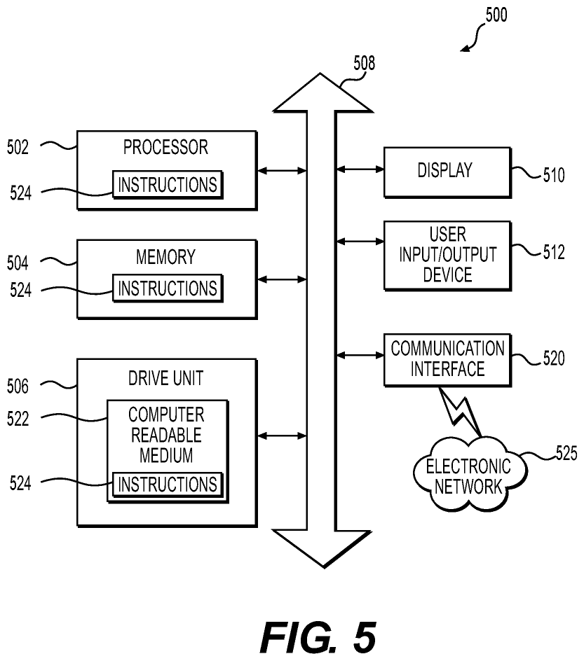

FIG. 5 depicts an example of a computer 500, according to certain embodiments. FIG. 5 is a simplified functional block diagram of a computer 500 that may be configured as a device for executing processes or operations depicted in, or described with respect to, FIGS. 1-4I, according to exemplary embodiments of the present disclosure. For example, the computer 500 may be configured as the user device 102, server device 104, and/or another device according to exemplary embodiments of this disclosure. In various embodiments, any of the systems herein may be a computer 500 including, e.g., a data communication interface 520 for packet data communication. The computer 500 may communicate with one or more other computers 500 using the electronic network 525. The network interfaces 114A, B in FIG. 1 may include one or more communication interfaces 520. The electronic network 525 may include a wired or wireless network similar to the network 106 depicted in FIG. 1.

The computer 500 also may include a central processing unit (“CPU”), in the form of one or more processors 502, for executing program instructions 524. The processors 110A, B depicted in FIG. 1 may include one or more processors 502. The computer 500 may include an internal communication bus 508, and a drive unit 506 (such as read-only memory (ROM), hard disk drive (HDD), solid-state disk drive (SDD), etc.) that may store data on a computer readable medium 522, although the computer 500 may receive programming and data via network communications. The computer 500 may also have a memory 504 (such as random access memory (RAM)) storing instructions 524 for executing techniques presented herein, although the instructions 524 may be stored temporarily or permanently within other modules of the computer 500 (e.g., processor 502 and/or computer readable medium 522). The memories 112A, B depicted in FIG. 1 may include one or more memories 504. The computer 500 also may include user input and output ports 512 and/or a display 510 to connect with input and output devices such as keyboards, mice, touchscreens, monitors, displays, etc. The displays 108A, B may include one or more displays 510. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another, e.g., from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features. For example, while some of the embodiments above pertain to processing tabular data using first and second machine learning models, any suitable activity may be used. In an exemplary embodiment, instead of or in addition to processing tabular data, certain embodiments include processing data other than tabular data.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to processing tabular data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for customized processing and visualization of data, comprising:
receiving, by a server device, tabular data;
receiving a first user input of a description of the tabular data and a second user input of a recipient of the tabular data or a report to be generated based on the tabular data;
converting the tabular data to a text-based language to form converted tabular data;
performing, using one or more first machine learning models, pre-processing of the converted tabular data based on the description or the recipient, wherein different first machine learning models have been trained to perform different pre-processing operations for different descriptions or different recipients;
applying one or more second machine learning models to the converted tabular data based on the description, the recipient, a context of the converted tabular data, or a characteristic of the converted tabular data, wherein different second machine learning models have been trained and are applied for the different descriptions, the different recipients, different contexts, different characteristics, or different visualizations; and
performing one or more actions based on a result of applying the one or more second machine learning models, the one or more actions including:
providing a virtual dashboard to visualize the converted tabular data or the result, and
generating one or more reports for the converted tabular data or the result.

2. The method according to claim 1, wherein the converting of the tabular data further comprises:
converting the tabular data to a JavaScript Object Notation (JSON) format or an extensible markup language (XML) format.

3. The method according to claim 1, further comprising:
selecting the one or more first machine learning models from multiple possible first machine learning models based on the description or the recipient; and
wherein the performing of the pre-processing further comprises:
performing the pre-processing using the one or more selected first machine learning models.

4. The method according to claim 1, further comprising:
selecting the one or more second machine learning models based on the description, the recipient, the context, or the characteristic; and
wherein the applying of the one or more second machine learning models further comprises:
applying the one or more selected second machine learning models.

5. The method according to claim 1, wherein the performing of the pre-processing further comprises:
applying a formatting to the converted tabular data.

6. The method according to claim 1, wherein the applying of the one or more second machine learning models further comprises:
processing the converted tabular data to perform a calculation or an analysis.

7. The method according to claim 1, wherein the one or more actions further comprise:
sending a message that includes the one or more generated reports, or
storing the one or more generated reports.

8. The method according to claim 1, wherein the one or more actions further comprise:
determining one or more individuals to attend a meeting based on the one or more generated reports or a result of the applying of the one or more second machine learning models.

9. The method according to claim 8, further comprising:
scheduling the meeting for the one or more individuals;
generating a calendar invite for the meeting; and
sending the calendar invite to user devices associated with the one or more individuals.

10. The method according to claim 1, further comprising:
providing a user interface for display via a user device; and
wherein the receiving of the tabular data further comprises:
receiving the tabular data as a file upload via the user interface.

11. A server device, comprising:
at least one memory storing instructions; and
at least one processor executing the instructions to perform operations for customized processing and visualization of data, the operations including:
receiving tabular data;
receiving a first user input of a description of the tabular data and a second user input of a recipient of the tabular data or a report to be generated based on the tabular data;
converting the tabular data to a text-based language to form converted tabular data;
performing, using one or more first machine learning models, pre-processing of the converted tabular data based on the description or the recipient, wherein different first machine learning models have been trained to perform different pre-processing operations for different descriptions or different recipients;
applying one or more second machine learning models to the converted tabular data based on the description, the recipient, a context of the converted tabular data, or a characteristic of the converted tabular data, wherein different second machine learning models have been trained and are applied for the different descriptions, the different recipients, different contexts, different characteristics, or different visualizations; and
performing one or more actions based on a result of applying the one or more second machine learning models, the one or more actions including:
providing a virtual dashboard to visualize the converted tabular data or the result, and
generating one or more reports for the converted tabular data or the result.

12. The server device according to claim 11, wherein the converting of the tabular data further comprises:
converting the tabular data to a JavaScript Object Notation (JSON) format or an extensible markup language (XML) format.

13. The server device according to claim 11, wherein the operations further comprise:
selecting the one or more first machine learning models from multiple possible first machine learning models based on the description or the recipient; and
wherein the performing of the pre-processing further comprises:
performing the pre-processing using the one or more selected first machine learning models.

14. The server device according to claim 11, wherein the operations further comprise selecting the one or more second machine learning models based on the description, the recipient, the context, or the characteristic; and
wherein the applying of the one or more second machine learning models further comprises:
applying the one or more selected second machine learning models.

15. The server device according to claim 11, wherein the performing of the pre-processing further comprises:
applying a formatting to the converted tabular data.

16. The server device according to claim 11, wherein the applying of the one or more second machine learning models further comprises:
processing the converted tabular data to perform a calculation or an analysis.

17. The server device according to claim 11, wherein the one or more actions further comprise:
sending a message that includes the one or more generated reports, or
storing the one or more generated reports.

18. The server device according to claim 11, wherein the one or more actions further comprise:
determining one or more individuals to attend a meeting based on the one or more generated reports or a result of the applying of the one or more second machine learning models.

19. The server device according to claim 18, wherein the operations further comprise:
scheduling the meeting for the one or more individuals;
generating a calendar invite for the meeting; and
sending the calendar invite to user devices associated with the one or more individuals.

20. A non-transitory computer-readable medium storing instructions that, when executed by a processor, cause the processor to perform a method for customized processing and visualization of data, the method comprising:
receiving tabular data;
receiving a first user input of a description of the tabular data and a second user input of a recipient of the tabular data or a report to be generated based on the tabular data;
converting the tabular data to a text-based language to form converted tabular data;
performing, using one or more first machine learning models, pre-processing of the converted tabular data based on the description or the recipient, wherein different first machine learning models have been trained to perform different pre-processing operations for different descriptions or different recipients;
applying one or more second machine learning models to the converted tabular data based on the description, the recipient, a context of the converted tabular data, or a characteristic of the converted tabular data, wherein different second machine learning models have been trained and are applied for the different descriptions, the different recipients, different contexts, different characteristics, or different visualizations; and
performing one or more actions based on a result of applying the one or more second machine learning models, the one or more actions including:
providing a virtual dashboard to visualize the converted tabular data or the result, and
generating one or more reports for the converted tabular data or the result.
